(19) United States
(12) Patent Application Publication
(10) Pub. No.: US 2011/0106409 A1
(43) Pub. Date: May 5, 2011

(54) METHOD AND DEVICE FOR THE PRESSURE WAVE COMPENSATION DURING CONSECUTIVE INJECTIONS IN AN INJECTION SYSTEM OF AN INTERNAL COMBUSTION ENGINE

(76) Inventors: Michael Walter, Kornwestheim (DE); Zoltan Papszt, Stuttgart (DE); Joachim Palmer, Korntal-Muenchingen (DE); Stefan Bollinger, Marbach Am Neckar (DE)

(21) Appl. No.: 12/999,014

(22) PCT Filed: Jun. 3, 2009
(86) PCT No.: PCT/EP2009/056778

§ 371 Date: Dec. 14, 2010

(30) Foreign Application Priority Data
Jul. 7, 2008 (DE) 102008040227.3

(51) Int. Cl. F02D 41/30

(52) U.S. Cl. 701/103

(57) ABSTRACT

A method and a device for controlling an injection system of an internal combustion engine are described, in which at least two consecutive partial injections are compensated for using pressure wave compensation, it is provided in particular that two test injections having a specified time interval to one another are triggered in a cylinder of the internal combustion engine, the total injection quantity of the at least two partial injections is ascertained, and a deviation between the ascertained total injection quantity and an expected total injection quantity is assumed as the error of the pressure wave compensation and a correction value for the pressure wave compensation is determined therefrom.

### FIELD OF THE INVENTION

The present invention relates to a method and device for the control of an injection system of an internal combustion engine, in a manner which compensates for pressure waves, during consecutive partial injections.

### BACKGROUND INFORMATION

In a common-rail diesel injection system, total injection quantities, which are calculated on the basis of an instantaneous demand on the part of the driver, are divided into a plurality of partial injection quantities, for example into two pilot-injections and one main injection in the partial load range. The injection quantities of these partial injections are to be as small as possible, in order to minimize emission disadvantages. On the other hand, however, the pilot-injections must be sufficiently large so that the minimum quantity required by the engine is always delivered, even in consideration of all tolerance sources. The consideration of the mentioned tolerance sources, which is known per se, as an allowance for the setpoint values of the pilot-injection quantities, has disadvantageous effects on the emissions, however.

Two possible tolerance sources for the quantity precision in the case of such partial injections are the drift of the particular injector and the pressure wave, which is caused by the opening and closing of the injector. Thus, a method and a device for the control of consecutive injections in an injection system of an internal combustion engine in a manner which compensates for pressure waves are disclosed in DE 10 2004 053 418 A1, in the case of which the injection quantity error triggered by the pressure wave is compensated for via a controlled pressure wave compensation.

This known method is used in particular for the purpose of measuring a new system via an injector test bench or an engine test bench using various injection scenarios, partial injection quantities, intervals between the injections, the rail pressure, and/or the fuel temperature being varied. The pressure wave effects thus measured are shown as quantity waves and stored in a control unit as the controlled compensation function—on the basis of similarly wave-like triggering times.

The quantity precision with respect to the chronologically second pilot-injection which is achievable using this related art is inadequate, however, for future tolerance requirements, which are derived from future emission limiting values. It is therefore desirable to improve the above-mentioned pressure wave compensation in such a way that the mentioned residual error in the case of a mentioned, controlled pressure wave compensation may be ascertained and adapted in the case of at least two consecutive partial injections in operation of an internal combustion engine or in driving operation of a motor vehicle having such an internal combustion engine.

### SUMMARY OF THE INVENTION

The exemplary embodiments and/or exemplary methods of the present invention is based on the idea of performing, an above-mentioned pressure wave compensation or a calibration of such a pressure wave compensation using at least two consecutive test injections.

In particular, it is proposed that a correction of the pressure wave compensation be ascertained, which may be in overrun operation of the internal combustion engine. According to an exemplary embodiment of the present invention, in the above-mentioned operating state of the internal combustion engine, two mentioned test injections, which may be two pilot-injections, having a specified time interval to one another, are triggered in a cylinder of the internal combustion engine, and a drift correction, which was already ascertained beforehand using the method of null quantity calibration, which is known per se, may be applied. The total injection quantity of both test injections is in turn ascertained according to the method of null quantity calibration. The deviation from the expected total injection quantity is interpreted as an error of the pressure wave compensation and a correction value for the pressure wave compensation is calculated therefrom. By changing the particular triggering times or other triggering parameters during the injection, this calculated correction value is iteratively varied until the measured total injection quantity results as the sum of the setpoint injection quantities of the two test injections.

The correction value of the pressure wave compensation which results in the case of the mentioned iteration is finally stored in a nonvolatile manner, which may be in an EEPROM of the injection system or a control unit of the internal combustion engine, and applied in the fired operation of the internal combustion engine or in driving operation of an underlying motor vehicle during the typical pressure wave compensation which is then performed.

In a specific embodiment, a counter pressure compensation is additionally introduced or provided, using which the efficiency of the pressure wave compensation may be further improved.

The advantage of the exemplary embodiments and/or exemplary methods of the present invention is that the setpoint value specification for the injection quantity of a chronologically second partial injection is typically reduced, which has an advantageous effect on the emissions of the internal combustion engine, while simultaneously relatively little noise is developed during the combustion.

The exemplary embodiments and/or exemplary methods of the present invention are described in greater detail hereafter on the basis of exemplary embodiments, which disclose further features and advantages of the present invention.

### BRIEF DESCRIPTION OF THE DRAWINGS

FIG. 1 shows a schematic representation of an injection system for metering fuel into an internal combustion engine according to the related art, in which the present invention may be used.

FIG. 2 shows a detailed representation of the calculation, which is known per se, of triggering times of an electrically operated valve shown in FIG. 1.

FIG. 3 shows a flow chart of an exemplary embodiment of the method according to the present invention.

FIG. 4a shows the graph of a typical amplitude error in the case of the pressure wave compensation.

FIG. 4b shows the graph of a typical phase error in the case of the pressure wave compensation.

FIG. 5 shows an exemplary embodiment of a device according to the present invention on the basis of a block diagram.

FIG. 6 shows a typical timeline of a pressure wave compensation according to the present invention in consideration of the cylinder counter pressure.

### DETAILED DESCRIPTION

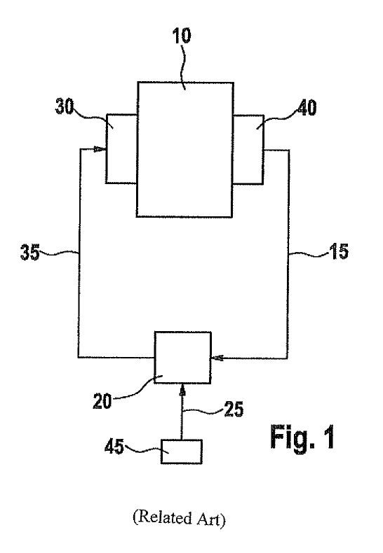

FIG. 1 shows a block diagram of the essential elements of a fuel metering system of an internal combustion engine, which is previously known from DE 199 45 618 A1. Internal combustion engine 10 receives a determined fuel quantity at a determined point in time metered by a fuel metering unit 30. Various sensors 40 detect measured values 15, which characterize the operating state of the internal combustion engine, and feed them to a control unit 20. Furthermore, various output signals 25 of further sensors 45 are fed to control unit 20. Detected measured values 15 characterize the state of the fuel metering unit, such as the driver intent. Control unit 20 calculates triggering pulses 35, which are to be applied to fuel metering unit 30, on the basis of these measured values 15 and further variables 25.

The internal combustion engine which is assumed in the present case may be a direct-injection and/or compression-ignition internal combustion engine. Fuel metering unit 30 may be implemented in various ways. Thus, for example, a distributor pump may be used as the fuel metering unit, in which a solenoid valve determines the point in time and/or the duration of the fuel injection.

Furthermore, the fuel metering unit may be implemented as a common-rail system. A high-pressure pump compresses fuel in an accumulator therein in a known manner. From this accumulator, the fuel reaches the combustion chambers of the internal combustion engine via injectors. The duration and/or the beginning of the fuel injection are controlled using the injectors. The injectors may contain a solenoid valve or a piezoelectric actuator.

Control unit 20 calculates the fuel quantity to be injected into the internal combustion engine in a way known per se. This calculation is performed as a function of various measured values 15, such as rotational speed n, the engine temperature, the actual injection beginning, and possibly still further variables 25, which characterize the operating state of the vehicle. These further variables are, for example, the position of the accelerator pedal or the pressure and the temperature of the ambient air. Control unit 20 converts the desired fuel quantity into appropriate triggering pulses of the injectors.

In the mentioned internal combustion engines, a small fuel quantity is frequently metered into the cylinder shortly before the actual main injection. The noise behavior of the engine may thus be substantially improved. This injection is referred to as the pilot-injection and the actual injection is referred to as the main injection. Furthermore, a small fuel quantity may be metered after the main injection. This is then referred to as the post-injection. Furthermore, the individual injections may be divided into further partial injections.

It is problematic in the case of such fuel metering systems that the electrically operated valves may meter different fuel quantities for the same triggering signal. The triggering time, during which fuel is directly metered, is a function of various factors in particular. This minimum triggering time results in an injection, while in contrast triggering times less than the minimum triggering, time do not result in an injection. This minimum triggering time is a function of various factors, such as the temperature, the fuel type, the service life, the rail pressure, manufacturing tolerances of the injectors, and further influences. In order to be able to achieve precise fuel metering, this minimum triggering time must be known.

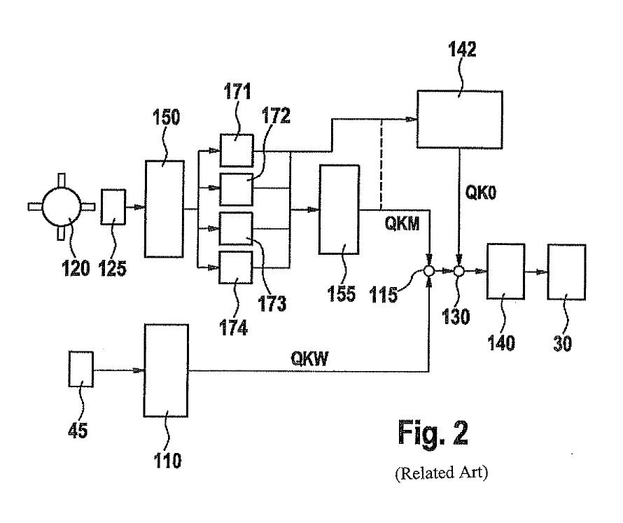

A device for controlling the fuel metering into an internal combustion engine, which is also described in DE 199 45 618 A1, is shown in FIG. 2. Elements already described in FIG. 1 are identified using corresponding reference numerals. Signals 25 of sensors 45 and further sensors (not shown) reach a quantity specification unit 110. This quantity specification unit 110 calculates a fuel quantity QKW, which corresponds to the driver intent. This quantity signal QKW reaches a node 115, to whose second input output signal QKM of a second synchronization unit 155 is applied. The output signal of first node 115 reaches a second node 130, which in turn applies it to a triggering time calculation unit 140. Signal QK0 of null quantity calibration unit 145 is applied to the second input of the second node. The quantity signals may be additively linked in both nodes 115 and 130. Triggering time calculation unit 140 calculates the triggering signal to be applied to fuel metering unit 30 on the basis of the output signal of node 130. The triggering time calculation unit calculates the triggering time which is to be applied to the electrically operated valves.

Various markings are positioned on a timing wheel 120, which are sampled by a sensor 125. In the illustrated exemplary embodiment, the timing wheel is a so-called segment wheel, which has a number of marks corresponding to the number of cylinders, which is four in the illustrated exemplary embodiment. This timing wheel may be situated on the crankshaft. This means a number of the pulses which corresponds to twice the number of cylinders is generated per engine revolution. Sensor 125 delivers a corresponding number of pulses to a first synchronization unit 150.

First synchronization unit 150 transmits signals to a first governor 171, a second governor 172, a third governor 173, and a fourth governor 174. The number of governors corresponds to the number of cylinders. The output signals of the four governors reach second synchronization unit 155. Furthermore, the output signals of the governors reach null quantity calibration unit 142. Alternatively, the output signal of the second synchronization unit may also be fed to null quantity calibration unit 142. This alternative is shown by a dashed line.

Such an apparatus, which is not equipped with null quantity calibration unit 142, is described in greater detail in DE 195 27 218. This apparatus operates as follows. On the basis of various signals, such as a signal which characterizes the driver intent, quantity specification unit 110 establishes desired fuel quantity signal QKW, which is required in order to provide the torque desired by the driver. In addition to the driver intent signal, still further signals may also be processed. In particular, the rotational speed signal and various temperature and pressure values are also processed in addition to the driver intent signal. Furthermore, the possibility exists that signals are transmitted to the quantity specification unit from other control units, which request a desired torque and/or a desired quantity. Such a further control unit may be a transmission controller, for example, which influences the torque from the engine during the shifting procedure.

Deviations arise between the desired injection quantity and the actual injected fuel quantity because of tolerances, in particular of fuel metering unit 30. The individual cylinders of the internal combustion engine typically meter different fuel quantities for the same triggering signal. These variations between the individual cylinders are typically corrected using a quantity compensation regulator (MAR). Such a quantity compensation regulator is schematically shown in the upper part of FIG. 2. For the quantity compensation regulation, a governor is assigned to each cylinder of the internal combustion engine. Thus, first governor 171 is assigned to the first cylinder, second governor 172 to the second cylinder, third governor 173 to the third cylinder, and fourth governor 174 to the fourth cylinder. Only one governor may also be provided, which is assigned alternately to the individual cylinders. Using sensor 125 and timing wheel 120, first synchronization unit 150 establishes a setpoint value and an actual value for each individual governor. Special filtering of the signal of sensor 125 is performed to compensate for tolerances of the timing wheel and to compensate for torsion oscillations. The output signals of governors 171 through 174 are fed to a second synchronization unit 155, which provides a correction quantity QKM, using which desired quantity QKW is corrected.

This quantity compensation regulator is implemented in such a way that the governors adjust the metered quantity to the individual cylinders to a common mean value. If a cylinder meters an elevated fuel quantity because of tolerances, a negative fuel quantity QKM is added to driver input quantity QKW for this cylinder. If a cylinder meters an insufficient fuel quantity, a positive fuel quantity QKM is added to driver input quantity QKW. A rotational irregularity occurs in the event of such quantity errors. This has the effect that oscillations, whose frequency corresponds to the camshaft frequency and/or multiples of the camshaft frequency, are superimposed on the rotational speed signal. These components in the rotational speed signal having camshaft frequency characterize the rotational irregularity and are corrected to zero by the quantity compensation regulator.

Quantity mean value errors cannot be corrected using this quantity compensation regulator. In particular, errors which arise because no fuel is metered below the mentioned minimum triggering time cannot be corrected using such a quantity compensation regulator.

If the vehicle is in overrun operation, i.e., no injection occurs, the internal combustion engine is equalized with respect to the fuel quantities injected into the individual cylinders. No components or only small components having camshaft frequency are therefore present in the rotational speed. If the triggering time of the injector is slowly increased in a cylinder N, an injection occurs in cylinder N above described minimum triggering time AD0(N). This results in a combustion irregularity, which in turn results in a rotational speed irregularity. Oscillations having multiples of the camshaft frequency occur in the rotational speed signal in particular. These camshaft frequency components are recognized by the quantity compensation regulator.

The governor corresponding to cylinder N determines a correction value. Upon the provision of the correction value of the quantity compensation regulator, null quantity calibration unit 142 recognizes triggering time AD0(N), during which an injection quantity just to be differentiated from the null quantity is injected. Corresponding value AD0(N) is stored and used during later metering for correction of the triggering time of cylinder N. This is shown in FIG. 2 in that value AD0(N) is used to calculate correction value QK0.

Furthermore, a method and a device for controlling a fuel metering system of an internal combustion engine are disclosed in DE 199 415 618 A1, in which the drift of an injector is adapted and compensated for via the method of null quantity calibration, which is known per se. In this method, the triggering time of at least one electrically operated valve is increased or reduced beginning from a start value and the triggering time during which fuel is currently injected is ascertained. The triggering time during which a change of a signal occurs is stored as the minimum triggering time. A variable which characterizes the rotation irregularity, an output signal of a lambda sensor, or an output signal of an ion current sensor is used as such a signal.

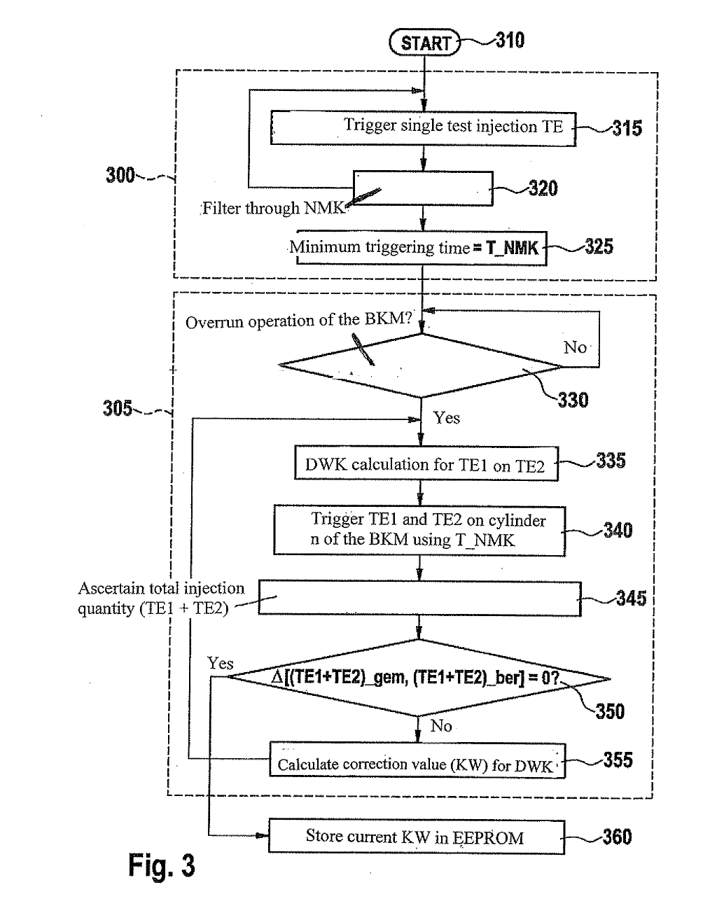

FIG. 3 shows a flow chart according to a first exemplary embodiment of the present invention. The routine shown therein is composed of a first learning phase 300 and a subsequent second learning phase 305.

After start 310 of the routine shown, in learning phase “1” 300, a single test injection TE is triggered 315 on a single cylinder n of an assumed internal combustion engine (BKM). This test injection corresponds in most cases to a pilot-injection; however, it may also be a post-injection or any other possible form of a partial injection. Using this test injection 315, a null quantity calibration (NMK) is performed in a way known per se in step 320, until a minimum triggering time T_NMK is provided 325, which is to be indicated by the program loop.

Accordingly, in learning phase “1” 300, the NMK according to the related art (i.e., for a single pilot-injection) is first completely learned; corrections of an injector quantity compensation (IMA) and a cylinder counter pressure compensation may be considered in a typical manner.

A method and a device for performing the injector quantity compensation are described, for example, in previously published DE 102 15 610 A1. The injector quantity compensation is based in general on the finding that manufacturing-related construction tolerances in the injectors, which are a function of the particular injector type, cause individually varying injection quantities of the injectors, in spite of identical triggering voltage. Therefore, the injectors are already subjected to an injector quantity compensation at the time of manufacturing, during which the individual injectors are triggered and correction data are ascertained for the triggering time or triggering voltage, in order to compensate for the mentioned individual differences in the injection quantities of the individual injectors. The mentioned correction data may be stored in a digital data memory, which is situated in each individual injector, and thus allow individual control of the particular injector by the engine control unit.

The calculation of the triggering data to control the injectors is performed using quantity characteristic maps, which contain the relationship between the injection quantity, the rail pressure, and the triggering time. The injector quantity compensation may only be performed in those characteristic map areas in which the injection quantity is measurably a function of the triggering time.

The described method of injector quantity compensation (IMA) may be applied in the case of the present invention.

The method of counter pressure compensation, which is also known per se, is discussed in DE 10 2006 026 876 A1. As already noted, the injection quantity error is substantially due to the fact that the injection quantity is a function of the combustion chamber pressure which prevails during the injection. The combustion chamber pressure during the pilot-injection and/or the post-injection deviates significantly from the combustion chamber pressure which prevails during the main injection. In particular in the case of hydraulically controlled injection systems, for example, in common-rail injectors having electrical triggering and having a control chamber, the needle opening behavior is a function of the equilibrium of forces at the nozzle needle. This equilibrium of forces is essentially determined by the pressure in the control chamber and the combustion chamber pressure and is additionally influenced via the cylinder pressure which is applied to the nozzle needle when the injector is closed, a high cylinder counter pressure supporting the opening behavior of the nozzle, i.e., the injection begins at an earlier point in time for identical electrical triggering. On the other hand, the injection rate is in turn a function of the counter pressure, i.e., at high counter pressure, the maximum injection rate is reduced, because the pressure differential between the rail pressure and the mentioned counter pressure becomes smaller. By taking into account the cylinder pressure, the metering precision may be increased. Furthermore, this has the advantage that the quantity correction functions, which have the injection quantity as the input variable, work at the correct operating point.

Based on present value T_NMK, the sequence now passes into second learning phase “2” 305. In this second learning phase 305, in the present exemplary embodiment, the sequence initially waits using query 330 and corresponding program loops until overrun operation of the BKM exists. If this operating mode exists, a pressure wave compensation (DWK) or DWK calculation for the pressure wave effect from TE1 to TE2 is performed in a way known per se according to step 335. The method described in DE 10 2004 053 418 A1 may be applied.

Based on the value of the pressure wave compensation which is calculated in step 335, two test injections TE1 and TE2 are performed in step 340, again at single cylinder n, using triggering time T_NMK, which results from first learning phase 300. In addition, in step 345, total injection quantity ME_GES=ME(TE1)+ME(TE2) of both test injections TE1 and TE2 is ascertained according to the principle of null quantity calibration.

It is to be noted that the calculation of the DWK in step 335 thus has an effect on step 340 in that the corrections ascertained during the DWK must be considered during the test injections TE1 and TE2 in a step. Specifically, the relationship applies in this case that second test injection TE2 is performed using triggering time T_NMK (DWK correction) (latter converted into a triggering time).

In following step 350, a setpoint/actual comparison is performed, in which it is checked whether detected actual quantity ME(TE1+TE2)_gem corresponds to setpoint quantity ME(TE1+TE2)_ber, i.e., difference Δ of these two variables is equal to zero or is at least within an empirically specifiable threshold value close to zero. If not, a new correction value KW for the pressure wave compensation is iteratively calculated or established in step 355. Otherwise, the sequence jumps to step 360, in which current correction value KW_current is finally stored in the mentioned EEPROM and therefore is available in the fired operation of the internal combustion engine or in driving operation of an underlying motor vehicle during the typical pressure wave compensation.

In learning phase “2” 305, the two test injections are accordingly performed using the previously ascertained drift correction from learning phase 1; corrections of an IMA and a cylinder counter pressure compensation may also be considered here in a typical manner. In addition, the pressure wave compensation for the effect of the chronologically first pilot-injection on the chronologically second pilot-injection is calculated and the result is used. The pressure wave compensation is calculated according to the related art; however, it should be emphasized that the pressure wave compensation is used according to the present invention during the calibration of one of multiple pilot-injections.

As described, the total injection quantity of both test injections is ascertained according to the principle of the NMK, in a way known per se from a rotational speed, oxygen, and/or ion flow signal. A correction value which has already been learned is incorporated in the calculation of a particular correction value for the pressure wave compensation as per the method according to the present invention.

In addition to the described basic principle of the present invention, different variants with respect to the manipulated variable, which is varied in the calibration procedure, and the assigned feedback branch into the pressure wave compensation are possible, of which three variants will be described in greater detail.

### 1. Amplitude Error

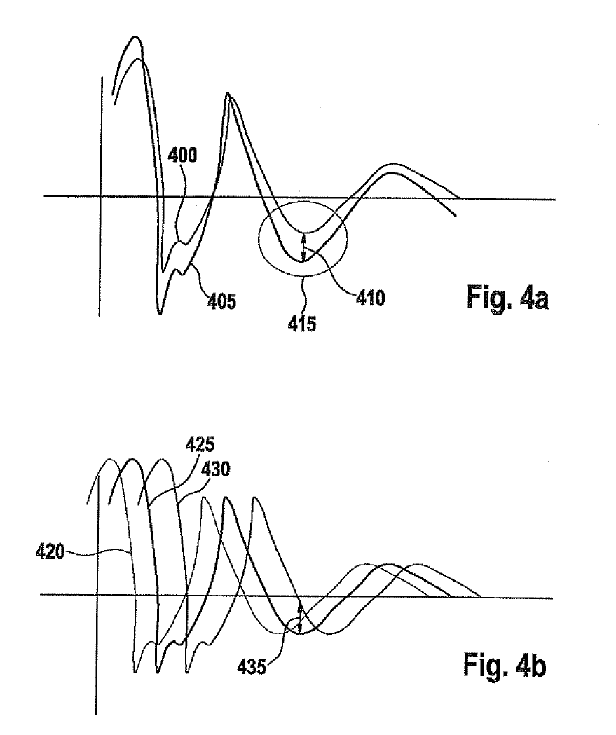

The above-described calibration sequence is based on the assumption that the dominant error of the pressure wave compensation is an amplitude error (see FIG. 4a). In FIG. 4a, a measured pressure wave curve 400 as a manipulated variable and a pressure wave curve 405, which results in the mentioned feedback branch into the pressure wave compensation, are compared. In circled curve section 415, an amplitude deviation 410 results between both curves 400, 405 in the present case. In order to consider this amplitude error, the triggering time of the chronologically second test injection is varied while the time interval of both test injections TE1, TE2 remains fixed, which essentially causes a change of the pressure wave amplitude. The feedback branch into the pressure wave compensation is set in consideration of the amplitude of the quantity wave.

A possible cause of the mentioned amplitude error is the typical procedure during the measurement of the pressure wave compensation, which is normally performed on a hydraulic test bench using testing oil. Differences in the damping between real diesel fuel and testing oil may cause the amplitude error.

### 2. Phase Error

Alternatively, the exemplary embodiments and/or exemplary methods of the present invention allows a phase error (FIG. 4b) of the pressure wave compensation to be learned using the method. For this purpose, with the triggering times of the two partial injections or test injections remaining fixed, the time interval between the two injections is varied in such a way that three phase-shifted pressure wave curves 420, 425, and 430 shown here result. Thus, phase shift 435 shown results between both curves 425, 430. A feedback branch into the pressure wave compensation is selected accordingly, which is incorporated in the consideration of the phase.

One possible cause of the mentioned phase error is that the electrical interval between the injections, which is known in the control unit, for example, functions as the input variable in the pressure wave compensation with respect to the phase of the pressure wave. However, the hydraulic interval of the pressure wave is relevant for the real pressure wave. Due to the aging of the injectors, the switch from electrical to hydraulic interval, which is stored in the calibration of the DWK, is no longer valid in the aged state, whereby a phase error arises.

### 3. Frequency Error

The frequency of the quantity or pressure wave may be detected by suitable variation of the interval between both test injections TE1 and TE2, either on the basis of the interval of zero crossings or on the basis of the interval of two minimum/maximum (MIN/MAX) peaks. For this purpose, in contrast to variant 2 (phase error), the interval is not iterated in the direction of a target value of the total injection quantity. Rather, to determine the frequency of the quantity wave or pressure wave, the total injection quantity is measured over a predefined parameter range of the interval in each case. A feedback branch into the pressure wave compensation is selected accordingly, which is incorporated in the consideration of the frequency.

One possible cause of the mentioned frequency error is the dependence of the frequency of the pressure wave on the fuel temperature and the rail pressure, in particular in the fuel supply line, these two variables only being known imprecisely. The following applies in detail for these variables:
a. The temperature for the determination of the frequency of the pressure wave is calculated according to the related art as a mixed temperature from the fuel temperature (this sensor is seated in the supply of the high-pressure pump) and the coolant temperature. The real temperature in the line may only be simulated in a coarse approximation by the existing structure, in particular in dynamic operation.
b. The rail pressure in the line is known due to the rail sensor; however, it is assumed that the pressure at the position of the sensor is equal to the pressure in the line, which is approximately valid while neglecting pressure oscillations in the rail and throttling losses. The individual sensor error of the rail pressure sensor additionally acts in its entirety on the tolerance of the pressure wave compensation.

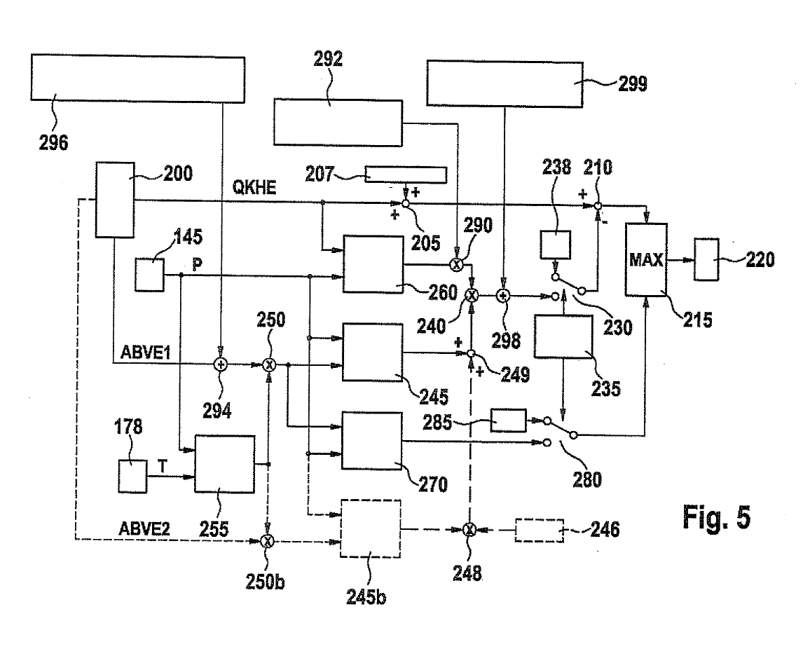

A block diagram of an exemplary embodiment of a device according to the present invention for controlling an injection system of interest here is shown in FIG. 5. The structure shown therein may be contained in a control unit of an internal combustion engine (not shown here). In particular, the structure is implemented as a program for performing the corresponding method.

The method described hereafter for operation of such a device applies in particular for the correction of the influence of a first test injection on a following second test injection and the influence of the second test injection on an immediately following main injection. In a particularly advantageous embodiment, the influence of two test injections on the main injection is corrected.

The correction is described hereafter on the example of the correction of the quantity of the main injection QKHE. A quantity specification unit 200 determines a signal QKHE, which characterizes the injection quantity during the main injection. This signal is applied to a node 205. The output signal of a quantity compensation governor 207 is also applied with a positive sign to the second input of node 205. The output signal of node 205 arrives, with a positive sign, at a second node 210, which in turn applies it to a maximum selection unit 215. The output signal of maximum selection unit 215 is applied to a characteristic map calculation unit 220, which establishes the triggering time for the injectors from the quantity variables and further variables, such as the fuel pressure.

The output signal of a switching arrangement 230, which alternatively relays the output signal of a null value specification unit 238 or of a node 240 to node 210, is applied with a negative sign to the second input of node 210. Switching arrangement 230 is acted upon by triggering signals of a correction controller 235. Node 240 links the output signal of a basic value specification unit 245 and the output signal of a weighting factor specification unit 260, which may be by multiplication.

Output signal QKHE of quantity specification unit 200 and output signal P of rail pressure sensor 145 are supplied to weighting factor specification unit 260. Basic value specification unit 245 processes output signal P of pressure sensor 145 and the output signal of a node 250. A signal which characterizes interval ABVE1 between the two partial injections is supplied to node 250 from quantity specification unit 200. Furthermore, a correction factor, which is determined by a temperature correction unit 255, is supplied to node 250. Temperature correction unit 255 processes output signal T of a temperature sensor 178 and output signal P of pressure rail pressure sensor 145.

The output signal of pressure sensor 145 and the output signal of node 250 are also supplied to a minimum value specification unit 270. This signal reaches a switching arrangement 280, to whose second input the output signal of a minimum value specification unit 285 is applied. Switching arrangement 280 relays one of the two signals, as a function of the triggering signal of one of correction controllers 235, to a second input of maximum selection 215.

In a particularly advantageous embodiment, it is provided that the influence of a second partial injection is also considered, which is chronologically before the first partial injection. This specific embodiment is shown by dashed lines. A further basic value specification unit 245b processes output signal P of pressure sensor 145 and the output signal of a node 250b. A signal, which characterizes interval ABVE2 between the partial injection to be corrected and the partial injection whose interval is considered, is supplied to node 250b from quantity specification unit 200. The output signal of basic value specification unit 245b is linked in a further node 248 to the signal of a weighting unit 246, which considers the influence, which is attenuated by the interposed injection.

Fuel quantity QKHE to be injected of the main injection, as a function of various operating parameters such as the driver intent and the rotational speed, is stored in quantity specification unit 200. This value is corrected in node 205 by the output signal of quantity compensation governor 207. The quantity compensation governor ensures that all cylinders contribute the same torque to the total torque. Variations of the injectors in the injected fuel quantity and/or influences on the combustion which result in unequal torques are compensated for by the quantity compensation governors.

Fuel quantity QKHE to be injected for the main injection, which is thus calculated, is corrected in node 210 using a correction value, which compensates for the influence of the pressure oscillations due to the test injection. The correction value is essentially composed of the basic value and a weighting factor, which are linked by multiplication in node 240.

The basic value is stored in basic value specification unit 245, which may be implemented as a characteristic map. The basic value is output from the characteristic map of basic value specification unit 245 as a function of rail pressure P and a corrected interval ABVE1 between the two partial injections. The dependence of the basic value on the interval may represent a periodic function, which is influenced by the pressure oscillations. Basic value specification unit 245 essentially considers the frequency of the pressure oscillations.

If the influence of the still earlier partial injections is also considered, two basic values are calculated for the two partial injections to be considered. The basic value, which may be calculated by additive linkage, is thus used.

The weighting factor is specified by weighting factor specification unit 260, which is also implemented as a characteristic map, as a function of rail pressure P and the fuel quantity to be injected during the injection to be corrected. The weighting specification unit essentially considers the amplitude of the pressure oscillations. The two values are subsequently multiplied.

In this specific embodiment, the basic value is specified on the basis of variables which characterize rail pressure P and a corrected interval ABVE1 between the two partial injections. The weighting factor is specified on the basis of variables which characterize rail pressure P and the fuel quantity to be injected during the injection to be corrected.

Using switch 230, the correction may be rendered nonfunctional in specific operating states. In these operating states, in which no correction is performed, the value 0 is specified as the correction value by null value specification unit 238.

It is particularly advantageous if interval ABVE1 between the two partial injections is corrected as the function of the temperature. For this purpose, a corresponding correction factor is stored in particular as a function of rail pressure P and/or temperature T in temperature correction unit 255. Interval ABVE1 is multiplied in node 250 by this correction factor. A correction of interval ABVE2 is also performed correspondingly in node 250b.

The fuel temperature, which is detected using a suitable sensor, may be used as the temperature. Fuel quantity QKH to be injected for the main injection, which is thus corrected, is compared in maximum selection unit 215 to a minimum representable fuel quantity. This quantity is read out from a characteristic map using minimum value specification unit 270 as a function of the rail pressure and interval ABVE1 and/or interval ABVE2 between the particular partial injections.

The basic value of the correction quantity is calculated from a characteristic map as a function of rail pressure P and the preferably temperature-corrected interval of the two partial injections. Characteristic map 245 contains the offset of the injection quantity using prior injection with respect to the fuel quantity without prior injection at constant fuel temperature as a function of rail pressure and the interval of the two partial injections. The basic value considers the dependence of the pressure oscillations and thus the correction quantity on the time interval of the two partial injections. This time curve of the correction is also a function of the rail pressure to a small extent.

This characteristic map is ascertained on the pump test bench and/or on the engine test bench using the injection quantities or injection durations which are typical for the particular pressure. The interval which was ascertained by quantity specification unit 200 is corrected using the correction factor, which may also be read out from a characteristic map as a function of rail pressure and fuel temperature, and scaled to the reference temperature of the basic characteristic map. This characteristic map may be derived from fuel data or also measured on the test bench. The interval corrected in this manner is used as the input variable for the characteristic map for calculating the basic value.

The correction quantity which is calculated from the basic characteristic map is subsequently multiplied by the weighting factor from the characteristic map stored in weighting factor specification unit 260 as a function of rail pressure and injection quantity of the injection to be corrected in order to adapt the correction quantity to the injection quantities, which deviate from the injection quantity considered in the basic characteristic map. This characteristic map is also determined on the test bench for one or two fixed intervals ABVE1 between the two partial injections. These intervals are selected in such a way that a quantity maximum and/or a quantity minimum occurs in them in the basic characteristic map.

The correction value which is thus ascertained, which represents the offset to an injection without prior injection, is derived in the node from desired injection quantity 210 and supplied to maximum value selection unit 215. This value is compared in maximum value selection unit 215 to a minimum quantity, which is read out from the characteristic map of minimum specification unit 270. The minimum quantity is also calculated as a function of the rail pressure and the interval of the two partial injections. To ascertain the characteristic map, the triggering time of the injectors is set to the minimum triggering time for the particular rail pressure.

The above-described method according to the present invention may be implemented by modifying the device shown in FIG. 5, the described learning phases being implemented by feedback branches described hereafter.

The described three variants of the feedback according to the present invention are shown in FIG. 5. Because all types of error occur in practice, the practical implementation of an intervention for an arbitrary error is shown in the present exemplary embodiment. In addition, an amplitude error is assumed hereafter as an example for all possible types of error. In the cases of other or mixed errors, it may be advantageous to use different interfaces than the shown interface during the pressure wave compensation.

If a positive control deviation is established during the testing in step 350 according to FIG. 3, i.e., the measured injection quantity of both test injections TE1 and TE2 is greater than a specified setpoint quantity, a positive correction value is calculated 292 and this value is linked to the output of structure 260 (FIG. 5) at a node 290. This linkage 290 may be performed by addition, multiplication, or in another complex manner, for example, on the basis of a characteristic curve. The mentioned increase of the measured injection quantity results in an increased result of logically following node 240 and, because of the negative sign, a reduction in the result at the output of further logically following node 210. The resulting triggering time is thus also reduced. During the following calibration sequence, a reduced injection quantity accordingly results in step 345 (FIG. 3).

The described iteration is performed until criterion 350, which is shown in FIG. 3, is met and the sequence transitions in this case to step 360.

In the case of a phase error, feedback 296 may alternatively be performed downstream from block 200 using a node 294, whereby mentioned interval ABVE1 is established. This results in a variation of the result of logically following node 250 and thus implicitly, namely via elements 245, 249, 240, . . . , in a variation of the result of final logically following node 210.

If the type of the prevailing error is unknown, or multiple types of error occur simultaneously, it may be advantageous to situate a feedback 299 at the output of node 240 to a logically following node 298. The linkage may again be performed by addition, multiplication, or in the mentioned complex manner. Such a configuration also ensures an intervention in the mentioned iteration process via node 210.

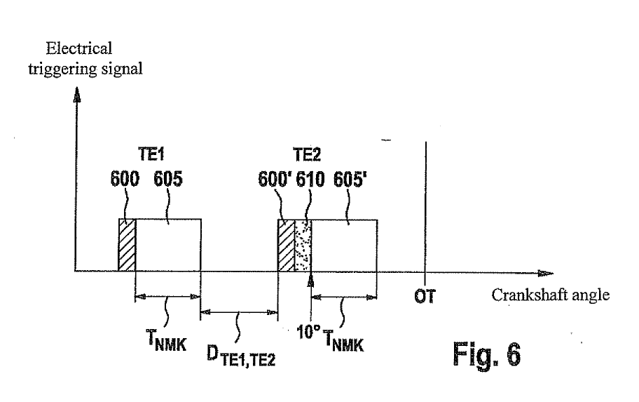

A typical time line of two consecutive test injections TE1 and TE2 is shown in FIG. 6, in each of which the mentioned “counter pressure compensation” is performed. In the diagram shown, the electrical triggering signal of an injection system (not shown) is plotted as a function of the crankshaft angle (KW angle). Top dead center (OT) is also shown. The positions of the crankshaft of an internal combustion engine in which the piston no longer executes a movement in the axial direction are referred to as “dead centers.” The location of the dead centers is uniquely determined by the geometry of crankshaft, connecting rod, and piston. One differentiates between top dead center (OT) (the piston top side is located close to the cylinder head) and bottom dead center (UT) (the piston top side is located at a distance from the cylinder head).

Test injection TE1 is composed in the present case of two control signal components 600, 605. Component 600 is a correction term due to the mentioned counter pressure compensation, while in contrast second component 605 is a term resulting from the null quantity calibration (NMK), having a time length T_{NMK}. According to the related art, variable T_{NMK} already contains the mentioned IMA and an above-described triggering time characteristic map.

After a time delay D_{TE1, TE2}, in the present case, second partial injection TE2 is performed. The triggering signal is in turn composed of a first correction term 600′, which results from the counter pressure compensation, and a second term 605′, which results from the null quantity calibration. It is to be indicated by the dashed line that terms 600 and 600′ or 605 and 605′ are not necessarily identical.

In contrast to first test injection TE1, the triggering signal contains a further correction term 610, which results from the pressure wave compensation (DWK), and which also includes the above-described iteration using feedback. Triggering component 610 ends at a crankshaft angle of 10° in the present exemplary embodiment.

Finally, it is to be emphasized that the above-described method and the device may be readily generalized to more than two partial injections, because the same principle may also be applied for more than two partial injections solely by appending a third learning phase employing three test injections, etc.

1-11. (canceled)

12. A method for controlling an injection system of an internal combustion engine, the method comprising:
compensating at least two consecutive partial injections using pressure wave compensation, wherein two test injections having a specified time interval to one another are triggered in a cylinder of the internal combustion engine;
ascertaining a total injection quantity of the at least two test injections; and
assuming a deviation between the ascertained total injection quantity and an expected total injection quantity is the error of the pressure wave compensation and determining a correction for the pressure wave compensation therefrom.

13. The method of claim 12, wherein a drift correction, which was previously ascertained using null quantity calibration, is applied during the triggering of the at least two test injections.

14. The method of claim 12, wherein a drift correction, which was previously ascertained using null quantity calibration, is applied during the ascertainment of the mentioned total injection quantity of the at least two test injections.

15. The method of claim 12, wherein the at least two test injections are performed in overrun operation of the internal combustion engine.

16. The method of claim 12, wherein the mentioned correction for the pressure wave compensation is varied by changing at least one triggering parameter, until the ascertained total injection quantity results as the sum of the setpoint injection quantities of the at least two test injections.

17. The method of claim 15, wherein the resulting correction is stored in a nonvolatile memory of the injection system or in a control unit of the internal combustion engine, and is applied in a fired operation of the internal combustion engine or in a driving operation of an underlying motor vehicle during the pressure wave compensation.

18. The method of claim 12, wherein there is a first learning phase, in which a partial injection is triggered and during which a null quantity calibration is performed, and wherein there is at least one second learning phase, in which at least two test injections are triggered, in consideration of a minimum triggering time, which results from the first learning phase, and in which a pressure wave compensation of the pressure wave effect of the first test injection on the at least second test injection is performed and in which the total injection quantity of the two test injections is ascertained using null quantity calibration.

19. The method of claim 12, wherein at least one of an amplitude error, a phase error, and a frequency error is considered as the manipulated variable during the pressure wave compensation.

20. A device for controlling an injection system of an internal combustion engine, comprising:
a compensation arrangement for compensating at least two consecutive partial injections using pressure wave compensation; and
a correction arrangement which ascertains a correction value as a function of the deviation between a measured injection quantity of the at least two partial injections and a specified setpoint quantity of the total injection of the at least two partial injections.

21. The device of claim 20, wherein the calculated correction value is fed using at least one linkage into the device for controlling the injection system so that a resulting triggering time decreases.

22. The device of claim 21, wherein the at least one linkage is performed by addition or multiplication, on the basis of a characteristic curve.
